(19) United States
(12) Patent Application Publication
(10) Pub. No.: US 2025/0277113 A1
(43) Pub. Date: Sep. 4, 2025

(54) PROCESS FOR PRODUCING OXIDIZED BITUMEN COMPOSITIONS

(71) Applicant: Kraton Corporation, The Woodlands, TX (US)

(72) Inventors: Andrew A. Ford, Tempe, AZ (US); Richard Blackwell, Houston, TX (US); Jeanne Kendrick, Cypress, TX (US)

(73) Assignee: Kraton Corporation, Houston, TX (US)

(21) Appl. No.: 19/067,850

(22) Filed: Mar. 1, 2025

Related U.S. Application Data
(60) Provisional application No. 63/559,478, filed on Feb. 29, 2024.

(51) Int. Cl. C08L 95/00

(52) U.S. Cl. CPC C08L 95/00; C08L 2555/22; C08L 2555/84

(57) ABSTRACT

The disclosure relates to a process for the production of an oxidized bituminous compound. The process includes providing bitumen and a polymeric modifier in separate feed streams and blowing oxygen-containing gas through the bitumen and polymeric modifier in an oxidizer. The process for preparing the bituminous composition reduces CO₂-equivalent by at least 10% compared to a process involving premixing bitumen and polymeric modifier, and/or oxidation of the bitumen alone.

### RELATED APPLICATIONS

This application claims the benefit of U.S. Provisional Application No. 63/559,478, filed on Feb. 29, 2024, incorporated herein by reference.

### FIELD

The present disclosure relates to a process for the production of oxidized bitumen.

### BACKGROUND

Oxidized bitumen (bitumen is also referred to as asphalt) is used by the roofing industry to make roofing shingles and roofing membranes, among other things. Oxidized bitumen, also called “blown bitumen” or “blown asphalt” is generally produced by oxidizing a suitable feedstock bitumen, or blends of bitumen, by blowing an oxygen-containing gas (e.g., air, oxygen or an oxygen-inert gas mixture) through the bitumen feedstock at an elevated temperature (usually between 400-550° F.) for a certain amount of time, typically more than a few hours. The bitumen can be combined with one or more catalysts or modifiers, e.g., waxes, polymers, etc., prior to oxidizing/blowing. The typical sequence involves pre-blending a modifier or catalyst with bitumen before subjecting the mixture to the oxidation process. This pre-blending step is usually performed at elevated temperatures to promote thorough mixing and dispersion of the modifier or catalyst in the bitumen. After mixing the bitumen with a modifier or catalyst, blowing oxygen or oxygen-containing gas through bitumen results in changes to the properties of the bitumen. Generally, the blowing process is terminated once the bitumen has obtained the desired penetration, softening point, and viscosity.

U.S. Pat. No. 7,576,148 discloses blown asphalt compositions in which a block copolymer is added to pre-heated bitumen and mixed together, prior to subjecting the bitumen-block copolymer mixture to a blowing process with an oxygen-containing gas.

While the above-described process is widely used in the industry, it has several shortcomings. For example, the process is time-consuming and energy consuming.

There remains a need for a method that reduces the amount of time to oxidize bitumen, thereby requiring less BTUs/energy and reducing emissions, e.g., filterable particulate, total organic compounds, carbon monoxide, HCl, VOC and NOₓ.

### SUMMARY

In an aspect, a process for preparing a bituminous composition is disclosed. The comprises a) providing a first feed stream comprising a bitumen preheated to at least 275° F.; b) providing a second feed stream comprising a polymeric modifier; c) charging the first feed stream and the second feed stream as separate feed streams to an oxidizer at a ratio of 1-25 parts by weight of the polymeric modifier to 100 parts by weight of the bitumen; d) blowing oxygen-containing gas at a gas flow rate of a least 5 l/min per kg of bitumen into the oxidizer when the oxidizer is at a temperature of at least 350° F.; c) maintaining the temperature of the oxidizer in a range of 400-550° F.; f) continuing the blowing of the oxygen-containing gas into the oxidizer to disperse and forma mixture of bitumen and polymeric modifier, and to oxidize the bitumen forming the bituminous composition; g) obtaining a sample of the bituminous composition from the oxidizer to measure for any of penetration value or softening point; and h) discharging the bituminous composition from the oxidizer when the bituminous composition has a penetration value of 15-75 units at 25° C., or a softening point of at least 185° F. The process for preparing the bituminous composition reduces CO₂-equivalent by at least 10% compared to a process involving premixing bitumen and polymeric modifier, and/or oxidation of the bitumen alone.

In another aspect, a process for preparing a bituminous composition is disclosed. The comprises a) providing a first feed stream comprising a bitumen preheated to at least 275° F.; b) providing a second feed stream comprising a polymeric modifier; c) charging the first feed stream and the second feed stream as separate feed streams to an oxidizer at a ratio of 1-25 parts by weight of the polymeric modifier to 100 parts by weight of the bitumen; d) blowing oxygen-containing gas at a gas flow rate of a least 5 l/min per kg of bitumen into the oxidizer when the oxidizer is at a temperature of at least 350° F.; c) maintaining the temperature of the oxidizer in a range of 400-550° F.; f) continuing the blowing of the oxygen-containing gas into the oxidizer to disperse and forma mixture of bitumen and polymeric modifier, and to oxidize the bitumen forming the bituminous composition; g) obtaining a sample of the bituminous composition from the oxidizer to measure for any of penetration value or softening point; and h) discharging the bituminous composition from the oxidizer when the bituminous composition has a penetration value of 15-75 units at 25° C., or a softening point of at least 185° F. The process for preparing the bituminous composition reduces CO₂-equivalent by at least 10% compared to a process involving premixing bitumen and polymeric modifier, and/or oxidation of the bitumen alone. The polymeric modifier is a styrenic block copolymer having a general configuration selected from A-B, A-B-A, B-A-B, A-B-A-B, A-B-A-B-A, (A-B)ₙ, (A-B)ₙ(A), (A-B)ₙ(A)ₘX, (A-B-A)ₙ, (A-B-A)ₙX, (A-B)ₙX, (B-A-B)ₙX, (B′-A-B)ₙX, (B-A-B′)ₙX, (A-B-A-B)ₙX, (A-B-A-B-A)ₙX, (A-B′-A-B)ₙX, (A-B-A-B′)ₙX, A-B′-A, B′-A-B, or B-A-B′, B′-A-B′, A-B′-A-B′, A-B′-A-B-A, A-B-A-B′-A, A-B′-A-B′-A, (A-B′)ₙ, (A-B′)ₙ(A), (A-B′)ₙ(A)ₘX, (A-B′-A)ₙ, (A-B′-A)ₙX, (A-B′)ₙX, (B′-A-B′)ₙX, (A-B′-A-B′)ₙX, (A-B′-A-B-A)ₙX, (A-B-A-B′-A)ₙX, (A-B′-A-B′-A)ₙX, and mixtures thereof. Each block A is composed of vinyl aromatic monomer units, and can be the same or different. Each block B is a homopolymer block of a conjugated diene monomer. Each block B′ is a copolymer block of a vinyl aromatic monomer and a conjugated diene monomer. n is an integer from 2 to 30, m is an integer from 1 to 30; and X is a residue of a coupling agent.

### DESCRIPTION

The following terms will be used throughout the specification.

“Consisting essentially of” means that the claimed composition primarily contains the specified materials, with allowances for additional components that do not materially affect novel characteristics or function of the claimed invention, with the additional components, if present, in an amount of <30%, or <20%, or <10%.

“At least one of [a group such as A, B, and C]” or “any of [a group such as A, B, and C]” means a single member from the group, more than one member from the group, or a combination of members from the group. For example, at least one of A, B, and C includes, for example, A only, B only, or C only, as well as A and B, A and C, B and C; or A, B, and C, or any other all combinations of A, B, and C.

A list of embodiments presented as “A, B, or C” is to be interpreted as including the embodiments, A only, B only, C only, “A or B,” “A or C,” “B or C,” or “A, B, or C.”

“Any of A, B, or C” refers to one option from A, B, or C.

“Any of A, B, and C” refers to one or more options from A, B, and C.

“Copolymer” refers to a polymer derived from more than one species of monomer.

“Block copolymer” refers to a copolymer that comprises more than one species of monomer, wherein the monomers are present in blocks. Each block is constituted of a set of monomer units different from the set of monomers of the connected surrounding blocks in the same block copolymer. Each block can be constituted of a homopolymer or a copolymer.

“Polystyrene content” or PSC of a block copolymer refers to the weight % of polymerized vinyl aromatic monomers, e.g., styrene, para-methylstyrene, etc., in the block copolymer, calculated by dividing the sum of molecular weight of all vinyl aromatic units by total molecular weight of the block copolymer. PSC can be determined using proton nuclear magnetic resonance spectroscopy (¹H NMR) and ¹³C NMR.

“Butylene unit content” refers to the content, in weight %, of the butylene units (“B”) relative to all diene based units in a given polymer (e.g., hydrogenated block copolymer). The butylene units are formed through the polymerization of 1,3-butadiene monomer via 1,2-addition, followed by hydrogenation. The 1,3-butadiene monomer can also polymerize through 1,4-addition, which, upon hydrogenation, results in ethylene units (“E”). Both butylene and ethylene units can be present in the hydrogenated block copolymer, which can also contain vinyl aromatic units and/or other units derived from conjugated diene monomers, arranged in any order. The butylene unit content can be measured by ¹H NMR and ¹³C NMR.

“Vinyl content” refers to the content of a conjugated diene that is polymerized via 1,2-addition in the case of butadiene, and/or via 3,4-addition in case of isoprene, resulting in a monosubstituted olefin, or vinyl group, adjacent to the polymer backbone. Vinyl content can be measured by nuclear magnetic resonance spectrometry (¹HNMR).

“Molecular weight” or Mw refers to the polystyrene equivalent molecular weight in kg/mol of a polymer block or a block copolymer. Mw can be measured with gel permeation chromatography (GPC) using polystyrene calibration standards, such as is done according to ASTM 5296. The GPC detector can be an ultraviolet or refractive index detector or a combination thereof. The chromatograph is calibrated using commercially available polystyrene molecular weight standards. Mw of polymers measured using GPC so calibrated are polystyrene equivalent molecular weights or apparent molecular weights. Mw expressed herein is measured at the peak of the GPC trace and is commonly referred to as polystyrene equivalent “peak molecular weight,” designated as Mp.

“Hydrogenation level” refers to the level (in %) of saturation of the double bonds (e.g., olefinic, aromatic, etc.) in a block copolymer, and can be measured by 1H NMR.

“Unit” refers to the structural building block derived from one monomer following its polymerization, representing a repeating entity that forms part of the polymer or copolymer chain. Unlike a “monomer,” which is the individual molecule before polymerization, a “unit” is the transformed version of the monomer after undergoing the polymerization process. A polymerized unit can be further transformed into a hydrogenated unit or a functionalized unit.

“Coupling efficiency” or CE refers to the weight of coupled polymer molecules divided by the total weight of both coupled and uncoupled polymer molecules, expressed as a percentage (%). CE can be used to determine the amount of diblock or more generally of “uncoupled arms” content in the overall block copolymer. For example, if the coupling efficiency is 80%, the polymer will contain 20 wt. % diblock or uncoupled arms and 80 wt. % triblock and multi-arm species.

“Controlled distribution” refers to a molecular structure having the following attributes: (1) terminal regions adjacent to the mono alkenyl arene homopolymer (“A”) blocks that are rich in (i.e., having a greater than average amount of) conjugated diene units; (2) one or more regions not adjacent to the A blocks that are rich in (i.e., having a greater than average amount of) monoalkenyl arene units; and (3) an overall structure having relatively low blockiness. The term, “rich in” is defined as greater than the average amount, preferably greater than 5 percent of the average amount.

“Vinyl Aromatic Blockiness Index” or VABI in the (co) polymer refers to the percentage of vinyl aromatic units with two adjacent vinyl aromatic units in the overall amount of vinyl aromatic units present in the polymer. VABI is measured using ¹HNMR spectroscopy of the (co) polymer and is mathematically given by the expression:

VABI=100×(Integral-2/Integral-1),

wherein Integral-1 is determined by integrating the ¹HNMR spectrum from 7.5 ppm to 6.0 ppm and dividing the result by 5; and Integral-2 is determined by integrating the ¹HNMR spectrum of the signal minimum region between 6.9 ppm and 6.6 ppm, to 6.0 ppm, and dividing the result by 2.

“Blown bitumen” refers to a bituminous base obtained at the end of a customary blowing operation. The blowing is carried out by circulating oxygen-containing air through a starting bitumen.

“Penetration” or “PEN” is measured according to ASTM D 5, and measures consistency of the bituminous composition. Higher values of penetration indicate softer consistency.

“Ring and ball softening point,” “softening point,” or “Tsp” of the bituminous composition is measured according to ASTM D 36 or ASTM D3461 Mettler Cup and Ball.

The disclosure relates to a process for oxidizing bitumen, wherein an oxygen-containing gas is blown through bitumen, polymeric modifier, and optional components without premixing.

Polymeric Modifier: The bituminous composition comprises a polymeric modifier. The polymeric modifiers can be in the form of crumb, pellet, powder, etc.

Polymeric modifiers can be any polymer traditionally used to modify bitumen/asphalt. Examples of polymeric modifiers include, but are not limited to, natural or synthetic rubbers (e.g., butyl, polybutadiene, polyisoprene or polyisobutene rubber), ethylene/vinyl acetate copolymer, ethylene/propylene/diene (EPDM) terpolymer, elastomeric polyolefin copolymers, copolymers of a vinyl aromatic compound (styrenic block copolymers and styrene-butadiene-rubbers), polyolefins, olefin acrylic copolymers, olefin acetate copolymers, and mixtures thereof.

In embodiments, the modifier is a styrenic block copolymer (“SBC”). The SBC can be used alone or in combination with one or more of the polymeric modifiers listed above.

In embodiments, the polymeric modifier is present in the bituminous composition in an amount of <25, or <20, or >2, or >5, or 1-25, or 5-20, or 5-15 parts by weight on the basis of 100 parts by weight of bitumen.

(Styrenic Block Copolymers) The SBC can be any of a diblock copolymer, triblock copolymer, tetrablock copolymer, pentablock copolymer; and any of linear or branched (multi-arm) block copolymer. The SBC comprises at least one block A composed of vinyl aromatic monomer units, and at least one rubbery block B consisting of conjugated diene monomer units and optionally vinyl aromatic monomer units. In embodiments, each block B′ is a mixture of vinyl aromatic monomer and conjugated diene monomer and can be any of tapered, random, block structure, or a controlled distribution copolymer block. The SBC can be hydrogenated (partially, selectively, or fully) or unhydrogenated. The vinyl aromatic units are derived from polymerized vinyl aromatic monomers, while the hydrogenated diene units, prior to hydrogenation, are derived from polymerized diene monomers.

In embodiments, the SBC has a general configuration selected from: A-B, A-B-A, B-A-B, A-B-A-B, A-B-A-B-A, (A-B)ₙ, (A-B)ₙ(A), (A-B)ₙ(A)ₘX, (A-B-A)ₙ, (A-B-A)ₙX, (A-B)ₙX, (B-A-B)ₙX, (B′-A-B)ₙX, (B-A-B′)ₙX, (A-B-A-B)ₙX, (A-B-A-B-A)ₙX, (A-B′-A-B)ₙX, (A-B-A-B′)ₙX, A-B′-A, B′-A-B, or B-A-B′, B′-A-B′, A-B′-A-B′, A-B′-A-B-A, A-B-A-B′-A, A-B′-A-B′-A, (A-B′)ₙ, (A-B′)ₙ(A), (A-B′)ₙ(A)ₘX, (A-B′-A)ₙ, (A-B′-A)ₙX, (A-B′)ₙX, (B′-A-B′)ₙX, (A-B′-A-B′)ₙX, (A-B′-A-B-A)ₙX, (A-B-A-B′-A)ₙX, (A-B′-A-B′-A)ₙX, and mixtures thereof; where n is an integer from 2 to 30, and m is an integer from 1 to 30; and X is residue of a coupling agent. If there are two or more A blocks in each configuration, each block A can be the same or different. Each block A is a homopolymer block of a vinyl aromatic monomer. Each block B is a homopolymer block of a conjugated diene monomer, and each block B′ is a copolymer block of a vinyl aromatic monomer and a conjugated diene monomer.

In embodiments, the coupling agent includes bi- or polyfunctional compounds, for example divinylbenzene, halides of aliphatic or araliphatic hydrocarbons, such as 1,2-dibromoethane, bis(chloromethyl)benzene, silicon tetrachloride, dialkyl- or diarylsilicon dichloride, alkyl- or arylsilicon trichloride, tin tetrachloride, alkylsilicon methoxides, alkyl silicon ethoxides, polyfunctional aldehydes, such as terephthalic dialdehyde, ketones, esters, anhydrides, or epoxides. In embodiments, the coupling agent is selected from methyltrimethoxysilane, methyltriethoxysilane, tetramethoxysilane, dimethyladipate, gamma-glycidoxypropyltrimethoxy silane, and mixtures thereof. In embodiments, the SBC has a coupling efficiency (CE) of >10%, or >20%, or 10-100%, or 20-95%, 50-95%, or 70-95%, >90%, or 80-98%, or 85-95%.

In embodiments, the vinyl aromatic monomer is selected from the group consisting of styrene, para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene, ortho-substituted styrene, meta-substituted styrene, alpha-methylstyrene, 1,1-diphenylethylene, and mixtures thereof.

In embodiments, the conjugated diene monomer is selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and mixtures thereof.

In embodiments, block A has a peak molecular weight of >1 kg/mol, or >5 kg/mol, or >7 kg/mol, or >10 kg/mol, or >15 kg/mol, or >30 kg/mol, or >40 kg/mol, or >50 kg/mol, or >75 kg/mol, or >100 kg/mol, or <200 kg/mol, or <150 kg/mol, or <100 kg/mol, or 1-200 kg/mol, or 1-150 kg/mol, or 1-100 kg/mol, or 1-75 kg/mol, or 1-50 kg/mol.

In embodiments, each block B and B′ independently has a peak molecular weight of >5 kg/mol, or >10 mg/mol, or >15 kg/mol, or >25 kg/mol, or >50 kg/mol, or <100 kg/mol, or <250 kg/mol, or 5-350 kg/mol, or 5-300 kg/mol, or 7-250 kg/mol, or 10-200 kg/mol, or 5-150 kg/mol, or 10-100 kg/mol.

In embodiments, the SBC has a total peak molecular weight of 5-1000 kg/mol, or 5-750 kg/mol, or 10-500 kg/mol, or 20-300 kg/mol, or 50-300 kg/mol, or 50-250 kg/mol, or <750 kg/mol, or <500 kg/mol, or >5 kg/mol, or >10 kg/mol, based on the total weight of the SBC.

In embodiments, the SBC has a total polystyrene content of >5 wt. %, or >10 wt. %, or <70 wt. %, or <60 wt. %, or <50 wt. %, or 1-60 wt. %, or 5-50 wt. %, or 20-40 wt. %. or 25-35 wt. %, based on the total weight of the SBC.

In embodiments, the SBC has a vinyl content, prior to hydrogenation, of ≥40 wt. %, or >50 wt. %, or >60 wt. %, or >70 wt. %, or 30-95 wt. %, or 40-95 wt. %, or 50-95 wt. %, or 60-95 wt. %, or 70-95 wt. %, or 70-90 wt. %, or 70-85 wt. %, based on total weight of polymerized conjugated diene monomers in the block B and the block B′ (if present).

In embodiments, the SBC has a diblock content of 0-100 wt. %, 0-90 wt. %, or 0-80 wt. %, or 0-70 wt. %, or 0-60 wt. %, or 0-50 wt. %, or 0-40 wt. %, or 0-30 wt. %, or <100 wt. %, or <75 wt. %, or <50 wt. %, or <30 wt. %, based on total weight of the respective SBC where the diblock content is present. In embodiments, wherein the SBC is coupled, the SBC has a diblock content of 0-30, or 0-25 wt. %, or 0-20 wt. %, or <30 wt. %, or <25 wt. %, or <20 wt. %, based on total weight of the respective SBC where the diblock content is present

In embodiments, the SBC is a hydrogenated SBC (HSBC) having polymerized vinyl aromatic units essentially left unhydrogenated and polymerized conjugated diene units being hydrogenated. In embodiments, each block A and block B′ (polymerized vinyl aromatic units), independently has a hydrogenation level of <30%, or <20%, or <10%, or <5%, based on total double bonds present in the block A and the block B′. In embodiments, each block B and block B′ (polymerized conjugated diene units), is independently hydrogenated to a hydrogenation level of >50%, or >55%, or >60%, or >65%, or >80%, or >85%, or >90%, or >95%, or >98%, or >99%, or up to 100%, or <90%, or 50-90%, or 55-85%, or 60-80%, or 65-90%, or 50-75%, or 80-99%, or 85-98, or 90-99%, or up to 100%, based on total double bonds present in the block B and the block B′. The hydrogenation level refers to the percentage of original unsaturated bonds which become saturated upon hydrogenation, which can be determined using UV-VIS spectrophotometry and/or proton NMR and/or via ozonolysis titration.

In embodiments, where the SBC is hydrogenated, each block B is a block selected from E/B, E/B/S, EP/MB, EP/MB/S, E/B/EP/MB and combinations thereof.

In embodiments, where the SBC is hydrogenated, block B is a block E/B composed of ethylene (“E”) units and butylene (“B”) units which are hydrogenated 1,4-butadiene units and hydrogenated 1,2-butadiene units, respectively.

In embodiments, where the SBC is hydrogenated, block B′ is a block E/B/S composed of ethylene (“E”) units, butylene (“B”) unit, and vinyl aromatic units (“S”).

In embodiments, where the SBC is hydrogenated, block B is a block EP/MB composed of ethylene-propylene (EP) units and methylene-butylene (MB) units. Each EP unit is a hydrogenated 1,4-isoprene unit and each MB unit is a hydrogenated 3,4-isoprene unit and/or a hydrogenated 1,2-isoprene unit. In embodiments, the methylene-butylene (MB) units are present in the block EP/MB in amounts of <10, or <8, or <5 wt. %, based on total weight of the block EP/MB.

In embodiments, where the SBC is hydrogenated, block B′ is a block EP/MB/S composed of ethylene-propylene (EP) units, methylene-butylene (MB) units, and vinyl aromatic units.

In embodiments, where the SBC is hydrogenated, block B is a block E/B/EP/MB composed of ethylene (“E”) units, butylene (“B”) units, ethylene-propylene (EP) units, and methylene-butylene (MB) units.

The SBC can be functionalized with at least one functional group, e.g., hydroxyl group, an amino group, a carboxyl group, an acid anhydride group, an epoxy group, an isocyanate group, a silanol group, and the like.

In embodiments, the SBC has a general configuration selected from: A-B-A, B-A-B, (A-B)ₙ, (A-B)ₙ(A), (A-B-A)ₙ, B′-A-B, or B-A-B′, or B′-A-B′, A-B′-A, (A-B′)ₙ, (A-B′)ₙ(A), (A-B′-A)ₙ, or mixtures thereof, and has:

a peak molecular weight of 50-300 kg/mol, or 50-250 kg/mol, or 70-250 kg/mol, or >50 kg/mol, or >60 kg/mol, or >70 kg/mol, or <350 kg/mol, or <300 kg/mol, or <250 kg/mol, based on the total weight of the SBC;
a peak molecular weight of the block A of >1 kg/mol, or >5 kg/mol, or >7 kg/mol, or >10 kg/mol, or >15 kg/mol, or <30 kg/mol, or 1-30 kg/mol, or 1-25 kg/mol, or 1-20 kg/mol, or 1-15 kg/mol, or 2-10 kg/mol, or 3-12 kg/mol, or 3-8 kg/mol;
a polystyrene content of >10 wt. %, or >15 wt. %, or >20 wt. %, or <50 wt. %, or 5-50 wt. %, or 5-40 wt. %, or 10-35 wt. %, based on the total weight of the SBC; and
a vinyl content, prior to hydrogenation, of ≥25 wt. %, or >30 wt. %, or <80 wt. %, or 25-80 wt. %, or 30-80 wt. %, or 35-75 wt. %, based on total weight of polymerized conjugated diene monomers in the block B and the block B′ (if present).

In embodiments, the SBC has a general configuration of: (A-B-A)ₙX, (A-B)ₙX, (B-A-B)ₙX, (A-B-A-B)ₙX, (A-B-A-B-A)ₙX, (A-B′-A)ₙX, (A-B′)ₙX, (B′-A-B)ₙX, (B-A-B′)ₙX, (B′-A-B′)ₙX, (A-B′-A-B)ₙX, (A-B-A-B′)ₙX, (A-B′-A-B′)ₙX, (A-B′-A-B-A)ₙX, (A-B-A-B′-A)ₙX, (A-B′-A-B′-A)ₙX, or mixtures thereof, and has:
a coupling efficiency (CE) of >80%, or >90%, or 80-100%, or 85-98%, or 90-95%;
a peak molecular weight of 50-500 kg/mol, or 50-400 kg/mol, or 50-300 kg/mol, or 50-250 kg/mol, or 70-250 kg/mol, or >50 kg/mol, or >60 kg/mol, or >70 kg/mol, or <500 kg/mol, or <350 kg/mol, or <300 kg/mol, or <250 kg/mol, based on the total weight of the SBC;
a peak molecular weight of the block A of >1 kg/mol, or >5 kg/mol, >15 kg/mol, or <10 kg/mol, or 1-15 kg/mol, or 1-10 kg/mol, or 5-10 kg/mol;
a polystyrene content of >10 wt. %, or >15 wt. %, or >20 wt. %, or <50 wt. %, or 5-50 wt. %, or 5-40 wt. %, or 10-35 wt. %, based on the total weight of the SBC; and
a vinyl content, prior to hydrogenation, of ≥70 wt. %, or 70-95 wt. %, or 70-90 wt. %, or 70-85 wt. %, based on total weight of polymerized conjugated diene monomers in the block B and the block B′ (if present).

In embodiments, the SBC has a general configuration of: A-B-A, B-A-B, (A-B)ₙ(A), (A-B-A)ₙ, (A-B-A)ₙX, (B-A-B)ₙX, A-B′-A, B′-A-B′, (A-B′)ₙ(A), (A-B′-A)ₙ, (A-B′-A)ₙX, (B′-A-B′)ₙX, or mixtures thereof, and has:
a vinyl content, prior to hydrogenation, of ≥70 wt. %, or >75 wt. %, or 70-95 wt. %, or 75-90 wt. %, or 70-80 wt. %, based on total weight of polymerized conjugated diene monomers in the block B and the block B′ (if present);
a peak molecular weight of the block A of >1 kg/mol, or >5 kg/mol, or >7 kg/mol, or >10 kg/mol, or >15 kg/mol, or <30 kg/mol, or 1-30 kg/mol, or 1-25 kg/mol, or 1-20 kg/mol, or 1-15 kg/mol, or 2-10 kg/mol, or 3-12 kg/mol, or 3-8 kg/mol;
a peak molecular weight of each block B and B′ of >5 kg/mol or >10 mg/mol, or >15 kg/mol, or >25 kg/mol, or >50 kg/mol, or 5-350 kg/mol, or 5-300 kg/mol, or 10-300 kg/mol, or 15-250 kg/mol, or 20-200 kg/mol, or 20-150 kg/mol;
a peak molecular weight of 10-500 kg/mol, or 20-300 kg/mol, or 50-250 kg/mol, or 20-240 kg/mol, or 70-270 kg/mol, based on the total weight of the SBC;
a total polystyrene content (PSC) of >5 wt. %, or >10 wt. %, or <70 wt. %, or <60 wt. %, or <50 wt. %, or 1-60 wt. %, or 5-50 wt. %, or 20-40 wt. %. or 25-35, based on the total weight of the SBC;
a diblock content of less than 25 wt. %, based on total weight of the respective SBC where the diblock content is present.

Bituminous Component: The bituminous component, also known as asphalt, can be a naturally occurring bitumen or derived from petroleum. Petroleum pitches obtained by a cracking process and coal tar can be used as the bituminous component as well as blends of various bituminous materials. Examples of suitable components include distillation or “straight-run bitumens,” precipitation bitumens, e.g., propane bitumens, and mixtures thereof. Other suitable bituminous components include mixtures of one or more of these bitumens with extenders (fluxes) such as petroleum extracts, e.g., aromatic extracts, distillates or residues, or with oils. Suitable bituminous components (either “straight-run bitumens” or “fluxed bitumens”) are those having a penetration in the range of from 50 to 300 units (equivalent to deci-millimeters, dmm) at 25° C. In applications where the flexibility, tackiness or adhesion of the product is of high importance, such as in roofing shingle applications, fluxed bitumen having penetrations in the range of greater than 300 units at 25° C. are of particular use.

Optional Components: Optional components such as waxes, catalysts, plasticizers, hardeners, inorganic filler, recycled materials, antioxidants, other suitable compounds, or any combination thereof, can be added to the bituminous composition.

Examples of waxes include natural and synthetic waxes.

Examples of catalysts include ferric chloride, phosphorous pentoxide, aluminum chloride, boric acid, copper sulfate, zinc chloride, phosphorous sesquesulfide, phosphorous pentasulfide, phytic acid, organic sulfonic acids, other metal salts and combinations thereof. In embodiments, the blown bitumen composition, and the method of making thereof does not require the use of a catalyst.

The plasticizers can include a naphthenic oil, an aliphatic oil, an aromatic oil, other forms of natural and synthetic oils, and combinations thereof.

In embodiments, optional components are present in the bituminous composition in an amount of <25, or <20, or >2, or >5, or 1-25, or 5-20, or 5-15 parts by weight on the basis of 100 parts by weight of bitumen.

Process of Preparation: Blowing in reference to bitumen preparation refers to a process or step to oxidize bitumen, modifying its physical properties, e.g., increasing softening point, decreasing penetration, thus making the bitumen a harder and a more viscous material. The oxidizing process typically includes blowing an oxygen-containing gas (for example, air, oxygen, or an oxygen-inert gas mixture) through bitumen in an oxidizer at elevated temperatures.

In embodiments, the oxidizer can be any of a blow still, a blowing tower, a reactor, or any other apparatus capable of blowing or oxidizing bitumen. The oxidizer is equipped with inlets for bitumen feedstock, air/oxygen, polymeric modifier, optional additives, etc.; a heating system; a cooling system; and outlet for products. In embodiments, the oxidizer comprises baffles, impellers, or agitators. The oxygen-containing gas can be supplied from the bottom or the side of the oxidizer, so long as it blows through the bitumen.

In a preferred embodiment, the oxidizer is a blow still. In embodiments, the blow still is sectionalized with perforated plates at various heights within the blow still, as disclosed in US Patent Publication No. 2018/0086982, incorporated herein by reference. In other embodiments, the blow still utilizes a recycle loop on the blow still (the bitumen could either be pulled from the top or the bottom of the blow still tank and then returned to the opposite end of the tank), as disclosed in U.S. Pat. No. 9,556,383, incorporated herein by reference.

The bitumen is fed separately from other feed streams to the oxidizer. In the process of preparing blown bitumen, the bitumen is pre-heated to at least 275° F., or at least 300° F., or at least 325° F., or at least 350° F. until molten, forming a pre-heated bitumen as a first feed stream to the oxidizer. The method of heating can vary based on the grade and characteristics of the bitumen but can include utilizing a heating tank or asphalt melter. A second feed stream to the oxidizer includes a polymeric modifier which can be added to the oxidizer before, after, or concurrently with the pre-heated bitumen. Other feed streams to the oxidizer can include one or more optional components, which can be added to the oxidizer before, after, or concurrently with the pre-heated bitumen. The process further includes charging the first feed stream and the second feed stream to the oxidizer at a ratio of 1-25 parts by weight of the polymeric modifier to 100 parts by weight of bitumen.

The polymeric modifier is sufficiently blended into the bitumen during the oxidation process with the blowing of the oxygen-containing gas forming a dispersed blend/mixture. In the blowing process, an oxygen-containing gas is bubbled or forced through the bitumen, polymeric modifier and optional components mixing them to form the blown bitumen. The polymeric modifier allows the blend/mixture to reach the final penetration value and softening point properties with reduced oxidation time. In embodiments, a sample of bituminous composition is obtained from the oxidizer to measure for any of penetration value or softening point. The bituminous composition is discharged from the oxidizing tank when the bituminous composition has a penetration value of at least 15 units at 25° C., or a softening point of at least 185° F.

In embodiments, flow rate of the oxygen-containing gas is at least 5 l/min, <50 l/min, or 5-50 l/min, or 5-40 l/min, or 5-30 l/min, or 5-25 l/min per kg of the bitumen-modifier mixture depending on the type of bitumen and polymeric modifier used.

The reaction produced by the blowing is exothermic, and in embodiments raises the temperature of the bitumen to at least 400° F., or >450° F., or >500° F., or 400-550° F., or 460-530° F., or 475-525° F., or 480-520° F., or 490-510° F. The temperature in the oxidizer can be maintained by methods known in the art, e.g., with the use of a water jacket or a water spray system.

The oxidation process is usually carried out at ambient pressure, although it can also be carried out at elevated pressure. The process can be carried out in batch mode or continuous mode. The processing time of a standard blowing process may take from about 1 to 8 hours, or 2 to 8 hours, or 3 to 8 hours, to reach the desired softening point and penetration values. The processing time is dependent on the process temperature, the gas flow rate, the characteristics of the bitumen including the presence of any additives, the design of the process equipment, the concentration of oxygen in the gas, and the desired product.

Advantages/Properties: The process provides a reduction of up to 10%, or up to 20%, or up to 30%, or up to 40% or up to 50% on the kg CO₂-equivalent generated during the blowing process and reduces the Global Warming Potential (GWP) compared to a process involving premixing bitumen and polymeric modifier.

In this process, after the blown bitumen is oxidized, it is discharged from the oxidizer and has at least one of the following:
a softening point of at least, 185-245° F., or 190-230° F., or 200-220° F., and
a penetration at 25° C. of at least 15 units, or >20 units, or <75 units, or <70 units, or <65 units, or <60 units, or <50 units, or <45 units, or <40 units, or 15-75 units, or 15-65 units, or 15-50 units, or 20-40 units.

Applications: The blown bitumen can be used in roofing products, including roofing shingles, roofing membranes (also known as roll roofing) and waterproof membranes for various construction applications (tunnel, commercial and residential building, etc.). The blown bitumen can also be used in sound deadening and undercoats for automobiles, pipe coating, sealant, carpet, railroad construct, crack filler, chip seal or microsurfacing.

Examples: The following illustrative examples are intended to be non-limiting. The following test methods are used.

Penetration of the neat bitumen and polymer modified bitumen was measured according to ASTM D5.

Ring and ball softening point of the polymer-modified bitumen was measured according to ASTM D36.

Viscosities were measured at a temperature of 350° F., 375° F., or 400° F. (as indicated) using a Brookfield viscometer.

The asphalt is a commercially available AC5 from Hunt, having a viscosity of 500 poise at 140° F., a PEN of approximately 150 units, and a ring-and-ball softening point in the range of 40 to 50° F.

The polymeric modifiers are hydrogenated styrenic block copolymers with details as shown in Table 1.

TABLE 1

| | | Block B | Diblock | | Vinyl | |
|---|---|---|---|---|---|---|
| | PSC | content | content | CE | content | |
| HSBCs | (wt. %) | (wt. %) | (wt. %) | (%) | (wt. %) | Structure |
| HSBC 1 | 12.5 | 87.5 | 7 | 93 | 78 | linear |
| HSBC 2 | 18.6 | | 7 | 93 | 78 | tri-arm |
| HSBC 3 | 30 | 70 | <1 | — | 40 | linear |
| | | | | | | sequential |
| | | | | | | triblock |

Examples 1-3: Asphalt is pre-heated to 400° F. and added to a blow still and heated to 500° F. Air sparging is started at about 20 liters per minute (lpm) and continues at 500° F. for 120 minutes. The oxidized asphalt is discharged from the blow still, and properties are measured, for an expected softening point of at least 85° C. and a penetration at 25° C. of at least 15 units.

Examples 4-6: Asphalt, as a first feed stream, is heated to at least 375° F. (to make asphalt pourable/movable) and added to a blow still. Polymeric modifier HSBC 1, HSBC 2, or HSBC 3 (Example 4, 5 and 6, respectively), as second feed stream, is added at 10 wt. % to the blow still. Air sparging is started at about 20 liters per minute (lpm) and the temperature is stabilized at about 500° F. The mixture is stirred using air-driven sparging and continued for about 60 minutes at about 500° F. The modified asphalt is then discharged from the still. A blend obtained is expected to have a softening point of at least 85° C. and a penetration at 25° C. of <75 units.

As illustrated above, Examples 4-6 need less oxidation time in order to provide an oxidized asphalt having the desired properties, of a softening point of at least 85° C. and a penetration at 25° C. of 15-75 units. Additionally, there is no need for the extra pre-blend step which requires energy and additional time. The process in Examples 4-6 reduces CO2-equivalent by at least 10% compared to the process of Examples 1-3 with oxidation of the bitumen alone.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

Unless otherwise specified, all technical and scientific terms used herein have the same meanings as commonly understood by one of skill in the art to which the disclosed disclosure belongs. The recitation of a genus of elements, materials, or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. A process for preparing a bituminous composition, the process comprising:
a) providing a first feed stream comprising a bitumen preheated to at least 275° F.;
b) providing a second feed stream comprising a polymeric modifier;
c) charging the first feed stream and the second feed stream as separate feed streams to an oxidizer at a ratio of 1-25 parts by weight of the polymeric modifier to 100 parts by weight of the bitumen;
d) blowing oxygen-containing gas at a gas flow rate of a least 5 l/min per kg of bitumen into the oxidizer when the oxidizer is at a temperature of at least 350° F.;
e) maintaining the temperature of the oxidizer in a range of 400-550° F.;
f) continuing the blowing of the oxygen-containing gas into the oxidizer to disperse and forma mixture of bitumen and polymeric modifier, and to oxidize the bitumen forming the bituminous composition; and
g) discharging the bituminous composition from the oxidizer when the bituminous composition has a penetration value of 15-75 units at 25° C., or a softening point of at least 185° F.;
wherein the process for preparing the bituminous composition reduces CO₂-equivalent by at least 10% compared to a process involving premixing bitumen and polymeric modifier, and/or oxidation of the bitumen alone.

2. The process of claim 1, wherein the polymeric modifier is selected from natural or synthetic rubbers, ethylene/vinyl acetate copolymers, ethylene/propylene/diene terpolymers, elastomeric polyolefin copolymers, copolymers of a vinyl aromatic compound, polyolefins, olefin acrylic copolymers, olefin acetate copolymers, and mixtures thereof.

3. The process of claim 2, wherein the copolymers of a vinyl aromatic compound is a styrenic block copolymer.

4. The process of claim 3, wherein the styrenic block copolymer has a general configuration selected from A-B, A-B-A, B-A-B, A-B-A-B, A-B-A-B-A, (A-B)ₙ, (A-B)ₙ(A), (A-B)ₙ(A)ₘX, (A-B-A)ₙ, (A-B-A)ₙX, (A-B)ₙX, (B-A-B)ₙX, (B′-A-B)ₙX, (B-A-B′)ₙX, (A-B-A-B)ₙX, (A-B-A-B-A)ₙX, (A-B′-A-B)ₙX, (A-B-A-B′)ₙX, A-B′-A, B′-A-B, or B-A-B′, B′-A-B′, A-B′-A-B′, A-B′-A-B-A, A-B-A-B′-A, A-B′-A-B′-A, (A-B′)ₙ, (A-B′)ₙ(A), (A-B′)ₙ(A)ₘX, (A-B′-A)ₙ, (A-B′-A)ₙX, (A-B′)ₙX, (B′-A-B′)ₙX, (A-B′-A-B′)ₙX, (A-B′-A-B-A)ₙX, (A-B-A-B′-A)ₙX, (A-B′-A-B′-A)ₙX, and mixtures thereof; wherein
each block A is composed of vinyl aromatic monomer units, and can be the same or different;
each block B is a homopolymer block of a conjugated diene monomer,
each block B′ is a copolymer block of a vinyl aromatic monomer and a conjugated diene monomer;
n is an integer from 2 to 30;
m is an integer from 1 to 30; and
X is a residue of a coupling agent.

5. The process of claim 4, wherein the vinyl aromatic monomer is selected from the group consisting of styrene, para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene, ortho-substituted styrene, meta-substituted styrene, alpha-methylstyrene, 1,1-diphenylethylene, and mixtures thereof.

6. The process of claim 4, wherein the conjugated diene monomer is selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and mixtures thereof.

7. The process of claim 4, wherein
block A has a peak molecular weight of 1-200 kg/mol;
block B has a peak molecular weight of 5-350 kg/mol; and
the styrenic block copolymer has a total peak molecular weight of 5-1000 kg/mol.

8. The process of claim 1, wherein the process further comprises obtaining a sample of the bituminous composition to measure for any of penetration value or softening point prior to discharging the bituminous composition from the oxidizer.

9. The process of claim 1, wherein the oxidizing tank comprises any of baffles, impellers, or agitators.

10. The process of claim 1, wherein the oxygen-containing gas is air.

11. The process of claim 1, wherein the oxidizer is a blow still.

12. The process of claim 1, wherein the process includes other feed streams comprising one or more optional components; wherein the one or more optional components are added to the oxidizer before, after, or concurrently with the bitumen.

13. The process of claim 1, wherein the bituminous composition has a softening point of 190-230° F. and a penetration at 25° C. of 15-65 units.

14. A bituminous composition produced by the method in claim 1.

15. The bituminous composition of claim 14, wherein the bituminous composition has a softening point of 185-245° F., and a penetration at 25° C. of 15-75 units.

16. A process for preparing a bituminous composition, the process comprising:
a) providing a first feed stream comprising a bitumen preheated to at least 275° F.;
b) providing a second feed stream comprising a polymeric modifier,
wherein the polymeric modifier is a styrenic block copolymer having a general configuration selected from A-B, A-B-A, B-A-B, A-B-A-B, A-B-A-B-A, (A-B)ₙ, (A-B)ₙ(A), (A-B)ₙ(A)ₘX, (A-B-A)ₙ, (A-B-A)ₙX, (A-B)ₙX, (B-A-B)ₙX, (B′-A-B)ₙX, (B-A-B′)ₙX, (A-B-A-B)ₙX, (A-B-A-B-A)ₙX, (A-B′-A-B)ₙX, (A-B-A-B′)ₙX, A-B′-A, B′-A-B, or B-A-B′, B′-A-B′, A-B′-A-B′, A-B′-A-B-A, A-B-A-B′-A, A-B′-A-B′-A, (A-B′)ₙ, (A-B′)ₙ(A), (A-B′)ₙ(A)ₘX, (A-B′-A)ₙ, (A-B′-A)ₙX, (A-B′)ₙX, (B′-A-B′)ₙX, (A-B′-A-B′)ₙX, (A-B′-A-B-A)ₙX, (A-B-A-B′-A)ₙX, (A-B′-A-B′-A)ₙX, and mixtures thereof; wherein
each block A is composed of vinyl aromatic monomer units, and can be the same or different;
each block B is a homopolymer block of a conjugated diene monomer,
each block B′ is a copolymer block of a vinyl aromatic monomer and a conjugated diene monomer;
n is an integer from 2 to 30;
m is an integer from 1 to 30; and
X is a residue of a coupling agent;
c) charging the first feed stream and the second feed stream as separate feed streams to an oxidizer at a ratio of 1-25 parts by weight of polymeric modifier to 100 parts by weight of the bitumen;
d) blowing oxygen-containing gas at a gas flow rate of a least 5 l/min per kg of bitumen into the oxidizer when the oxidizer is at a temperature of at least 350° F.;
e) maintaining the temperature of the oxidizer in a range of 400-550° F.;
f) continuing the blowing of the oxygen-containing gas into the oxidizer to disperse and forma mixture of bitumen and polymeric modifier, and to oxidize the bitumen forming the bituminous composition; and
g) discharging the bituminous composition from the oxidizing tank when the bituminous composition has a penetration value of at least 15 units at 25° C., or a softening point of at least 185° F.;
wherein the process for preparing the bituminous composition reduces CO₂-equivalent by at least 10% compared to a process involving premixing bitumen and polymeric modifier.

17. The process of claim 16, wherein the vinyl aromatic monomer is selected from the group consisting of styrene, para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene, ortho-substituted styrene, meta-substituted styrene, alpha-methylstyrene, 1,1-diphenylethylene, and mixtures thereof.

18. The process of claim 16, wherein the conjugated diene monomer is selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and mixtures thereof.

19. The process of claim 16, wherein the oxidizer is a blow still.

20. The process of claim 16, wherein the process includes other feed streams comprising one or more optional components; wherein the one or more optional components are added to the oxidizer before, after, or concurrently with the bitumen.
